(19) United States
(12) Patent Application Publication
(10) Pub. No.: US 2008/0232578 A1
(43) Pub. Date: Sep. 25, 2008

(54) ETHERNET VOLTAGE SOURCE APPARATUS AND METHOD

(76) Inventors: Steve Alan Schoenberg, Clifton Park, NY (US); Michael Jerry O'Connor, Saratoga Springs, NY (US); Jack P. Friedman, Schenectady, NY (US)

Correspondence Address: SCHMEISER, OLSEN & WATTS, 22 CENTURY HILL DRIVE, SUITE 302, LATHAM, NY, 12110, US

(21) Appl. No.: 11/687,683

(22) Filed: Mar. 19, 2007

(51) Int. Cl. H04M 9/00

(52) U.S. Cl. 379/413

(57) ABSTRACT

An Ethernet voltage source apparatus and method. The apparatus includes an electrical connector, a receiving circuit electrically connected to the Ethernet cable connector, a voltage regulator/power conditioning circuit electrically connected to the receiving circuit, and a first interface output connector electrically connected to the voltage regulator/power conditioning circuit. The receiving circuit receives a first voltage signal and an Ethernet data signal from the Ethernet cable. The receiving circuit separates the first voltage signal from the Ethernet data signal. The voltage regulator/power conditioning circuit generates a second voltage signal from the first voltage signal. The second voltage signal is configured as a first power source for an industrial/commercial device. The first interface output connector is configured to electrically connect the second voltage signal to the industrial/commercial device.

### FIELD OF THE INVENTION

The present invention relates to an apparatus and associated method for generating a voltage source from power retrieved from an Ethernet cable.

### BACKGROUND OF THE INVENTION

Applying power to various devices typically requires the use of an apparatus that may be costly and complicated. Accordingly, there exists a need in the art to overcome the deficiencies and limitations described herein above.

### SUMMARY OF THE INVENTION

The present invention provides a power supply comprising:

an Ethernet cable connector configured to interface said power supply to an Ethernet cable, wherein said Ethernet cable connector is further configured to receive a first voltage signal and an Ethernet data signal from said Ethernet cable;

a receiving circuit electrically connected to said Ethernet cable connector, wherein said receiving circuit is configured to separate said first voltage signal from said Ethernet data signal;

a voltage regulator/power conditioning circuit electrically connected to said receiving circuit, wherein said voltage regulator/power conditioning circuit is configured to generate a second voltage signal from said first voltage signal, wherein said second voltage signal comprises a different voltage from said first voltage signal, and wherein said second voltage signal is configured as a first power source for an industrial/commercial device; and

a first interface output connector electrically connected to said voltage regulator/power conditioning circuit, wherein said first interface output connector is configured to electrically connect said second voltage signal to said industrial/commercial device.

The present invention provides a power supply comprising:

an Ethernet cable connector configured to interface said power supply to an Ethernet cable, wherein said Ethernet cable connector is further configured to receive a first voltage signal and an Ethernet data signal from said Ethernet cable;

a receiving circuit electrically connected to said Ethernet cable connector, wherein said receiving circuit is configured to separate said first voltage signal from said Ethernet data signal;

a voltage regulator/power conditioning circuit electrically connected to said receiving circuit, wherein said voltage regulator/power conditioning circuit is configured to generate a second voltage signal from said first voltage signal, wherein said second voltage signal comprises a different voltage from said first voltage signal, wherein said second voltage signal is configured to charge an electrical energy storage device, wherein said electrical energy storage device is configured as a second power source for supplying a third voltage signal to an industrial/commercial device if a fourth voltage signal from an external primary power source for said industrial/commercial device is disabled; and

a first interface output connector electrically connecting said voltage regulator/power conditioning circuit to said electrical energy storage device, wherein said first interface output connector is configured to electrically connect said second voltage signal to said electrical energy storage device.

The present invention provides a method comprising:

receiving, by a power supply, a first voltage signal and an Ethernet data signal from an Ethernet cable, said power supply comprising an Ethernet connector, a receiving circuit electrically connected to said Ethernet connector, a voltage regulator/power conditioning circuit electrically connected to said receiving circuit, and a first interface output connector electrically connected to said voltage regulator/power conditioning circuit, said power supply interfaced to, said to an Ethernet cable by said Ethernet connector;

separating, by said receiving circuit, said first voltage signal from said Ethernet data signal; and

generating, by said voltage regulator/power conditioning circuit, a second voltage signal from said first voltage signal, wherein said second voltage signal comprises a different voltage value from said first voltage signal, wherein said second voltage signal is configured as a first power source for an industrial/commercial device, and wherein said interface output connector is configured to electrically connect said second voltage signal to said industrial/commercial device.

The present invention advantageously provides an apparatus and method capable of applying power to various devices.

### BRIEF DESCRIPTION OF THE DRAWINGS

FIG. 1 illustrates a block diagram of a system comprising an Ethernet power supply, in accordance with embodiments of the present invention.

FIG. 2 illustrates a block diagram of an alternative to the system of FIG. 1, in accordance with embodiments of the present invention.

FIG. 3 illustrates a block diagram of a first alternative to the system of FIG. 2, in accordance with embodiments of the present invention.

FIG. 4 illustrates a block diagram of a second alternative to the system of FIG. 2, in accordance with embodiments of the present invention.

FIG. 5 illustrates a block diagram of an alternative to the system of FIG. 4, in accordance with embodiments of the present invention.

FIG. 6 illustrates a block diagram of a third alternative to the system of FIG. 2, in accordance with embodiments of the present invention.

FIG. 7 illustrates a block diagram of a fourth alternative to the system of FIG. 2, in accordance with embodiments of the present invention.

FIG. 8 illustrates a block diagram of a first alternative to the system of FIG. 7, in accordance with embodiments of the present invention.

FIG. 9 illustrates a block diagram of a second alternative to the system of FIG. 7, in accordance with embodiments of the present invention.

FIG. 10 illustrates a flowchart describing an algorithm used by the systems of FIGS. 1-9 for retrieving a power signal from an Ethernet cable and generating a regulated voltage output signal for powering a device, in accordance with embodiments of the present invention.

### DETAILED DESCRIPTION OF THE INVENTION

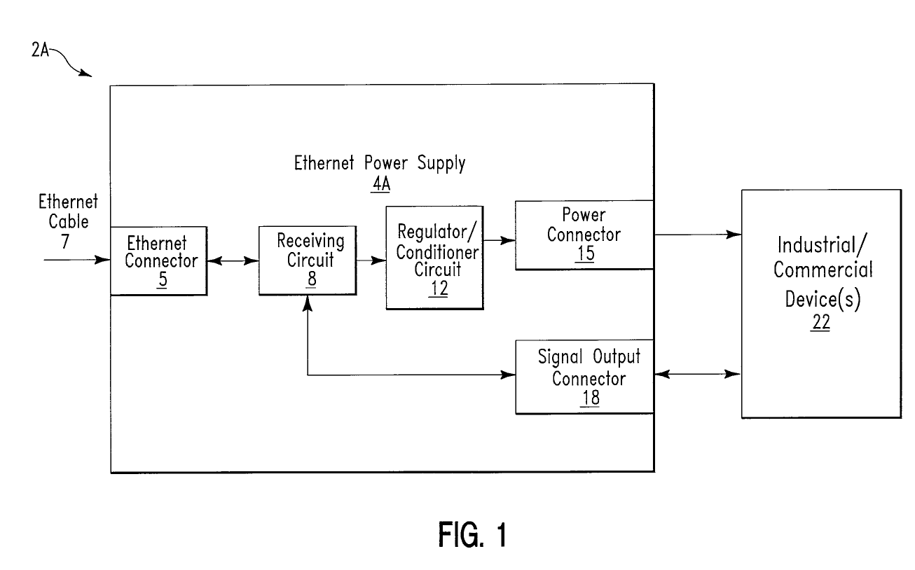

FIG. 1 illustrates a block diagram of a system 2A comprising an Ethernet power supply 4A, in accordance with embodiments of the present invention. System 2A comprises Ethernet power supply 4A, an Ethernet cable 7, and an industrial/commercial device 22. Ethernet cable 7 may comprise any type of Ethernet cable including, inter alia, Category 5 (or higher) cable. Ethernet cable 7 may comprise conductors of any gauge including, inter alia, 24 gauge, 22 gauge, etc. Ethernet cable 7 is used to retrieve data signals (e.g., I/O signals) and power signals (e.g., power over Ethernet (POE)) from an external apparatus (e.g., a computer). The power signals supplied by Ethernet cable 7 may be supplied via unused wiring pairs within Ethernet cable 7 (e.g., mid-span sourcing). Alternatively, the power signals supplied by Ethernet cable 7 may be combined with data signals (e.g., endpoint sourcing) on transmit and receive wiring pairs within Ethernet cable 7. The data signals from Ethernet cable 7 are passed through Ethernet power supply 4A to industrial/commercial device(s) 22. Industrial/commercial device(s) 22 may comprise any type of I/O device that is used in a controls/data acquisition environment. For example, industrial/commercial device(s) 22 may comprise, inter alia, industrial instrumentation (e.g., a fieldbus sensor, a transducer, a motor, an actuator, a switch, flow controller, etc), monitoring equipment, a control apparatus (e.g., a programmable logic controller (PLC)), etc. Additionally, industrial/commercial device(s) 22 may comprise any combination of the aforementioned industrial/commercial devices. Ethernet power supply 4A is used to retrieve a first power signal(s) (e.g., a voltage signal) from Ethernet cable 7 and condition the first power signal into a regulated voltage signal (i.e., an output voltage signal) suitable for powering or supplying power for industrial/commercial device(s) 22. The first power signal supplied through Ethernet cable 7 may be in compliance with the IEEE 802.3af standard.

Ethernet power supply 4A comprises an Ethernet connector 5, a receiving circuit 8 connected to Ethernet connector 5, a regulator/conditioning circuit 12 connected to receiving circuit 8, a power connector 15 connected to regulator/conditioning circuit 12, and a signal output connector 18 connected to receiving circuit 8. Ethernet connector 5 is used to interface Ethernet cable 7 to Ethernet power supply 4A. Ethernet connector 5 may comprise any type of Ethernet connector including, inter alia, an RJ45 connector, an M12 style connector, a Woodhead RJLyxx connector, an Amphenol RJField connector, etc. Data signals (e.g., I/O signals) and power signals retrieved from Ethernet cable 7 are transmitted through Ethernet connector 5 to receiving circuit 8. Receiving circuit 8 separates the power signal from the data signal. The data signal is transmitted from receiving circuit 8 through signal output connector 18 to industrial/commercial device(s) 22. The data signal may be used to control industrial/commercial device(s) 22, make a request for data from industrial/commercial device(s) 22, etc. The power signal is transmitted from receiving circuit 8 to regulator/conditioning circuit 12. Regulator/conditioning circuit 12 conditions the power signal into a regulated output voltage signal capable of powering or supplying power for industrial/commercial device(s) 22. The power signal is regulated to a desired voltage level. Regulator/conditioning circuit 12 may comprise current limiting circuitry in order to provide over voltage protection and short circuit protection for industrial/commercial device(s) 22. Regulator/conditioning circuit 12 may be designed to regulate the power signal retrieved from Ethernet cable 7 into a standard voltage signal for use in industrial or commercial systems (e.g., 12 VDC, 24 VDC, etc). Alternatively, regulator/conditioning circuit 12 may comprise a circuit for varying a value of the regulated output voltage signal.

Ethernet power supply 4A may comprise any type of enclosure for protecting the internal circuitry (i.e., receiving circuit 8, regulator/conditioning circuit 12, etc). The enclosure may comprise a rugged material or combination of materials for protecting the internal circuitry from weather related elements (e.g., rain, snow, etc) if used outdoors, industrial elements (e.g., water, dust, electrical surges, etc) if used in an industrial environment, etc. For example, the enclosure may comprise a plastic inner layer covered by a rubber outer layer.

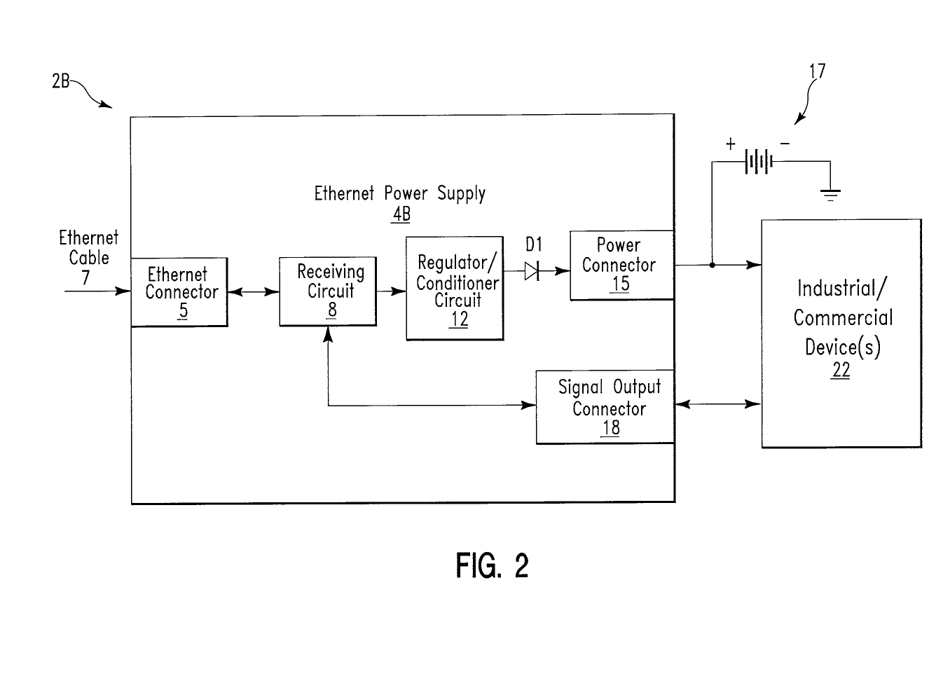

FIG. 2 illustrates a block diagram of a system 2B, in accordance with embodiments of the present invention. System 2B of FIG. 2 comprises an alternative to system 2A of FIG. 1. In contrast with Ethernet power supply 4A of FIG. 1, Ethernet power supply 4B of FIG. 2 comprises a diode D1 (e.g., a voltage directing circuit). In contrast with system 2A of FIG. 1, system 2B of FIG. 2 comprises a battery 17 (e.g., an electrical voltage storage device). Battery 17 may be alternatively routed through Ethernet power supply 4B (i.e., electrically connected to an output of D1). Battery 17 may comprise any type of rechargeable battery including, inter alia, lead acid, nickel metal hydride (NiMH), Alkaline, lithium ion, etc. In addition to conditioning a power signal (i.e., from Ethernet cable 7) into a regulated voltage output signal for supplying power to industrial/commercial device(s) 22, the regulated voltage output signal from regulator/conditioning circuit 12 maintains or provides a charge for battery 17. Charged battery 17 in combination with Ethernet power supply 4B forms an uninterruptible power source (UPS) that will continue to supply power (i.e., voltage) to industrial/commercial device(s) 22 if the power signal from Ethernet cable 7 is disabled or Ethernet power supply 4B is disabled. In the aforementioned scenario, battery 17 would continue to supply power to industrial/commercial device(s) 22. For example, battery 17 may comprise a lead acid type of battery that may be charged by applying a fixed regulated voltage of 14.1 VDC (i.e., from regulator/conditioning circuit 12). As battery 17 charges, a voltage on battery 17 floats up towards the fixed regulated voltage (i.e., 14.1 VDC) while reducing a current flow into battery 17. In this example, a charge rate for battery 17 is regulated to prevent overcharging and damage to battery 17. Diode D1 prevents a back flow of electrical current from battery 17 to regulator/conditioning circuit 12 thereby preventing damage to Ethernet power supply 4B. Additionally, diode D1 protects industrial/commercial device(s) 22 and Ethernet power supply 4B from damage in the event of a reverse polarity power connection.

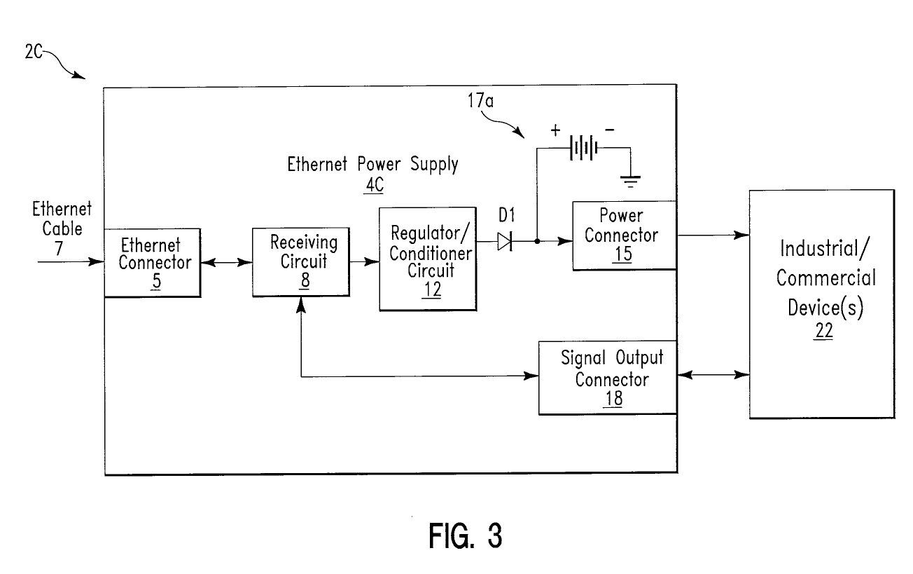

FIG. 3 illustrates a block diagram of a system 2C, in accordance with embodiments of the present invention. System 2C of FIG. 3 comprises a first alternative to system 2B of FIG. 2. In contrast with Ethernet power supply 4B of FIG. 2, Ethernet power supply 4C of FIG. 3 comprises a battery 17a internal to Ethernet power supply 4C (i.e., part of and within Ethernet power supply 4C). Battery 17a may comprise any type of rechargeable battery including, inter alia, lead acid, nickel metal hydride (NiMH), Alkaline, lithium ion, etc.

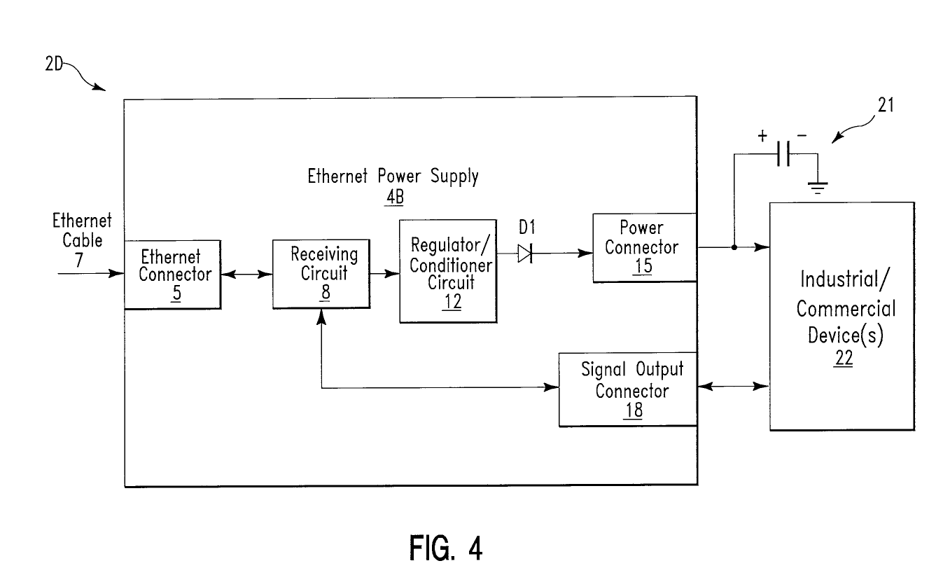

FIG. 4 illustrates a block diagram of a system 2D, in accordance with embodiments of the present invention. System 2D of FIG. 4 comprises a second alternative to system 2B of FIG. 2. In contrast to system 2B of FIG. 2, system 2D of FIG. 4 comprises a capacitor 21 (i.e., for an electrical energy storage device) instead of battery 17 (i.e., from FIG. 2) for receiving a charge from regulator/conditioning circuit 12 and supplying power to industrial/commercial device(s) 22.

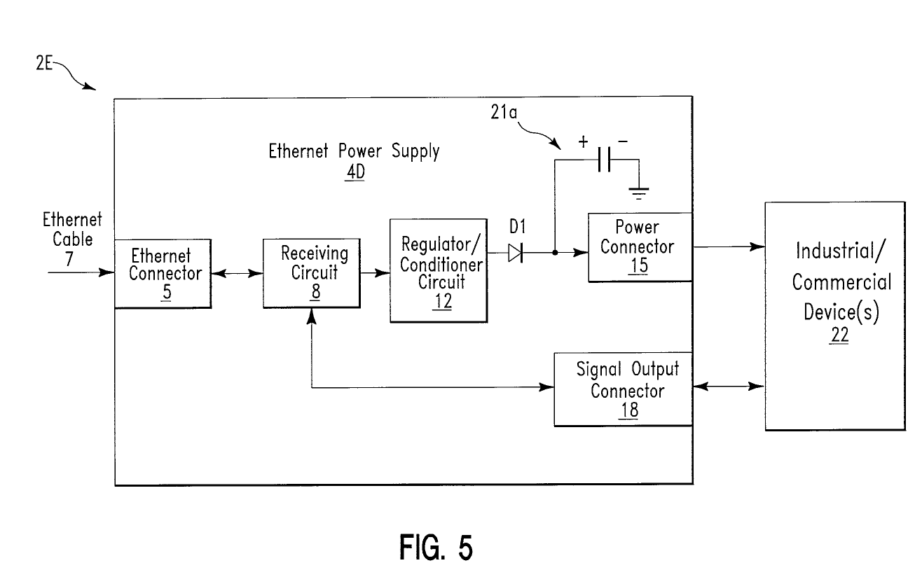

FIG. 5 illustrates a block diagram of a system 2E, in accordance with embodiments of the present invention. System 2E of FIG. 5 comprises an alternative to system 2D of FIG. 4. In contrast to system 2D of FIG. 4, system 2E of FIG. 5 comprises a capacitor 21 a internal to Ethernet power supply 4D (i.e., part of and within Ethernet power supply 4D).

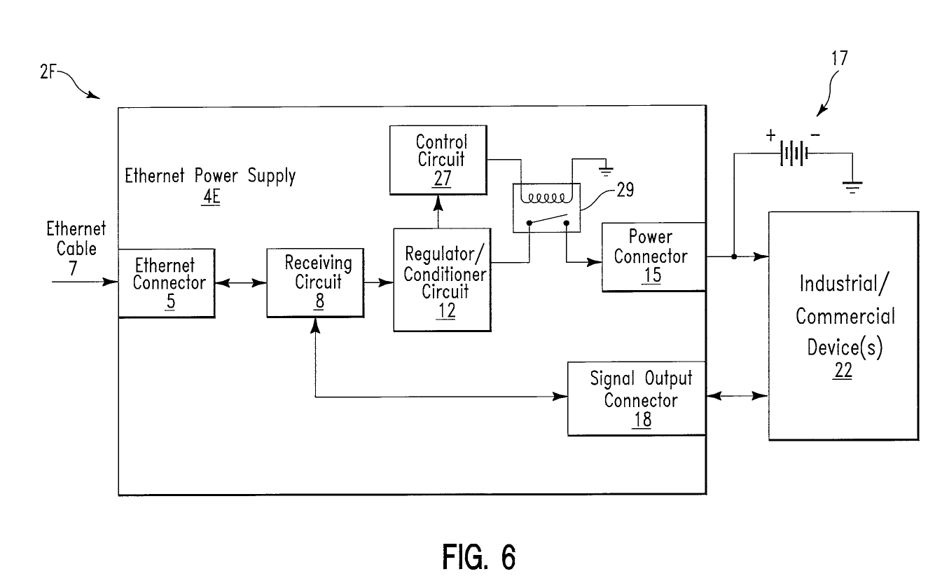

FIG. 6 illustrates a block diagram of a system 2F, in accordance with embodiments of the present invention. System 2F of FIG. 6 comprises a third alternative to system 2B of FIG. 2. In contrast with Ethernet power supply 4B of FIG. 2, Ethernet power supply 4E of FIG. 6 comprises a normally closed switching device 29 (i.e., in place of diode D1) and a control circuit 27. Switching device 29 and control circuit 27 (i.e., in combination) of FIG. 6 replace and perform the functions of diode D1 of FIG. 2 (i.e., preventing a backflow of current from battery 17 to regulator/conditioning circuit 12). Switching device 29 may comprise any type of switching device including, inter alia, a relay, etc. If control circuit 27 senses that regulator/conditioning circuit 12 is not providing an output voltage signal, control circuit 27 generates a control signal and transmits the control signal to switching device 29. In response, switching device 29 disables a circuit path between regulator/conditioning circuit 12 and power connector 15 thereby preventing a back flow of voltage from battery 17 to regulator/conditioning circuit 12. Alternatively, system 2F of FIG. 6 may comprise battery 17 internal to Ethernet power supply 4E (i.e., part of and within Ethernet power supply 4E).

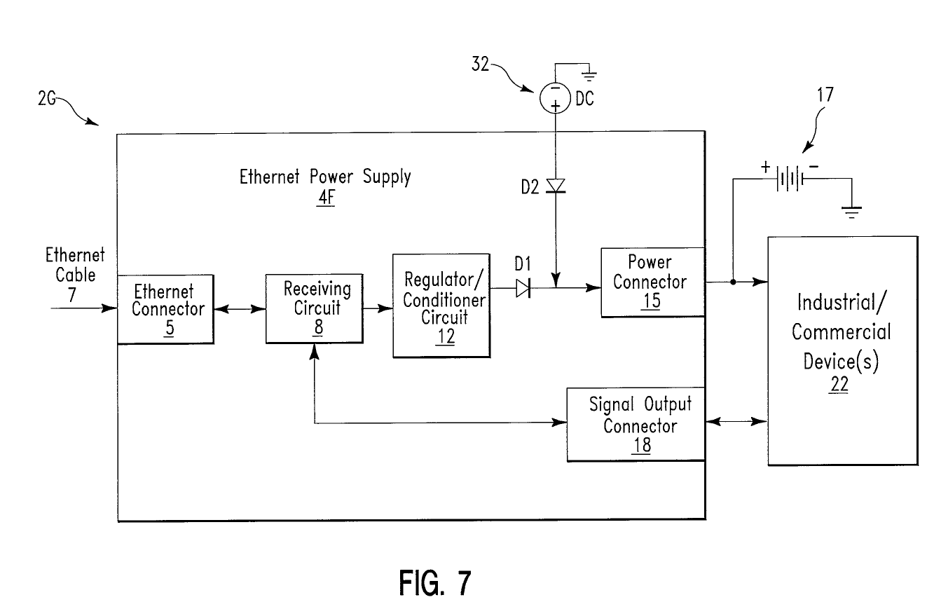

FIG. 7 illustrates a block diagram of a system 2G, in accordance with embodiments of the present invention. System 2G of FIG. 7 comprises a fourth alternative to system 2B of FIG. 2. In contrast with Ethernet power supply 4B of FIG. 2, Ethernet power supply 4F of FIG. 7 comprises an additional diode D2 (e.g., a voltage directing circuit). In contrast with system 2B of FIG. 2, system 2G of FIG. 7 comprises an external primary DC power supply 32 for supplying power (i.e., a regulated primary voltage) for industrial/commercial device(s) 22. Regulated voltage output signal from regulator/conditioning circuit 12 is used to charge battery 17. In this scenario, regulated voltage output signal from regulator/conditioning circuit 12 comprises a lower voltage (e.g., 14.1 VDC) than the regulated primary voltage signal from external primary DC power supply 32 (e.g., 24 VDC). If the regulated primary voltage signal from external primary DC power supply 32 is disabled, battery 17 is used to supply power (i.e., a voltage signal) for industrial/commercial device(s) 22. Diode D2 prevents a back flow of current from battery 17 or regulator/conditioning circuit 12 to external primary DC power supply 32. As an alternative, if the regulated primary voltage signal from external primary DC power supply 32 is disabled, Ethernet power supply 4F may be used to supply power (i.e., a voltage signal) for industrial/commercial device(s) 22 and if Ethernet power supply 4F is disabled battery 17 may used to supply power (i.e., a voltage signal) for industrial/commercial device(s) 22. Therefore, any of external primary DC power supply 32, Ethernet power supply 4F, or battery 17 may be used to supply power (i.e., a voltage signal) for industrial/commercial device(s) 22. Alternatively, system 2G of FIG. 7 may comprise battery 17 internal to Ethernet power supply 4F (i.e., part of and within Ethernet power supply 4E).

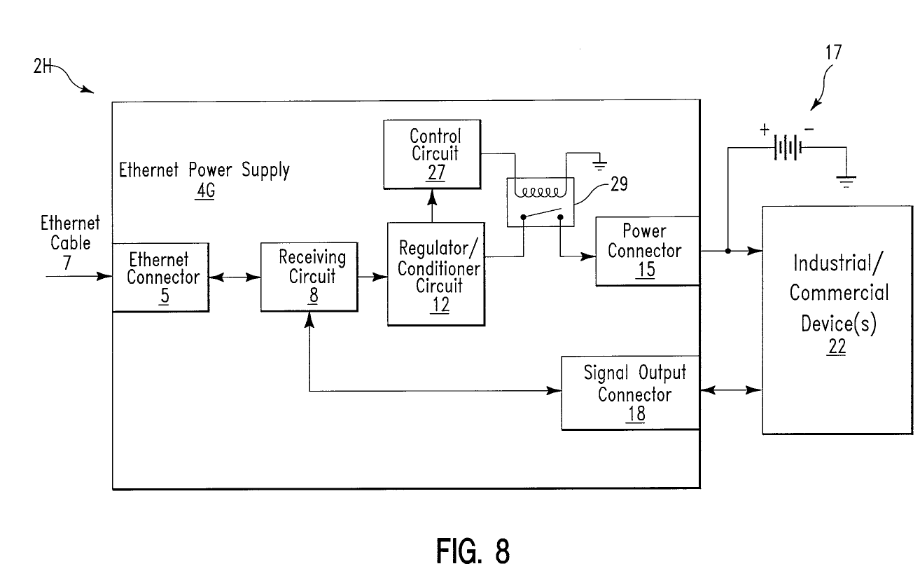

FIG. 8 illustrates a block diagram of a system 2H, in accordance with embodiments of the present invention. System 2H of FIG. 8 comprises a first alternative to system 2G of FIG. 7. In contrast with Ethernet power supply 4F of FIG. 7, Ethernet power supply 4G of FIG. 8 comprises a normally closed switching device 29b replacing diode D1 of Ethernet power supply 4F of FIG. 7 and a normally closed switching device 29a replacing diode D2 of Ethernet power supply 4F of FIG. 7. Control circuit 27 in combination with switching device 29b performs the functions of diode D1 of FIG. 7 (i.e., preventing a backflow of current from battery 17 to regulator/conditioning circuit 12). Control circuit 27 in combination with switching device 29a performs the functions of diode D2 (i.e., from FIG. 7, preventing a backflow of current from battery 17 or regulator/conditioning circuit 12 to external primary DC power supply 32). Alternatively, system 2H of FIG. 8 may comprise battery 17 internal to Ethernet power supply 4G (i.e., part of and within Ethernet power supply 4G).

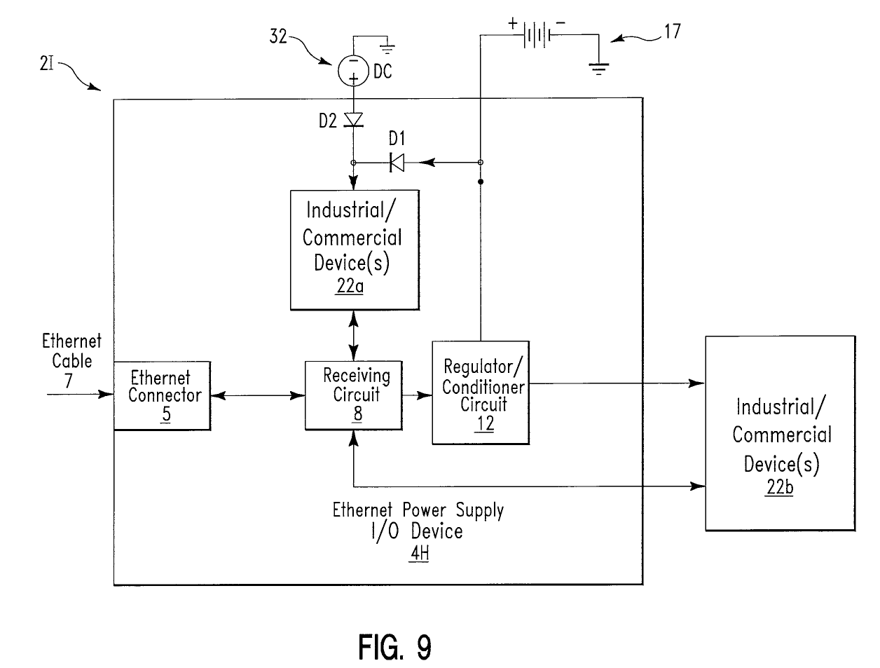

FIG. 9 illustrates a block diagram of a system 21, in accordance with embodiments of the present invention. System 21 of FIG. 9 comprises a second alternative to system 2G of FIG. 7. In contrast with Ethernet power supply 4F of FIG. 7, Ethernet power supply/industrial/commercial device 4H in FIG. 9 comprises an industrial/commercial device(s) 22a internal to Ethernet power supply/ industrial/commercial device 4H. Industrial/commercial device(s) 22a may comprise any type of commercial/Industrial I/O device that is used in a controls/data acquisition environment. For example, industrial/commercial device(s) 22a may comprise, inter alia, industrial instrumentation (e.g., a fieldbus sensor, a transducer, a motor, an actuator, a switch, flow controller, etc), monitoring equipment, a control apparatus (e.g., a programmable logic controller (PLC)), etc. Ethernet power supply/industrial/commercial device 4F is a stand-alone combination of any of Ethernet power supplies from FIGS. 2-8 and an industrial/commercial device. Regulator/conditioning circuit 12 may provide a regulated voltage output signal for powering industrial/commercial device(s) 22a and/or charging battery 17 as a backup power source for industrial/commercial device(s) 22a. Alternatively, regulator/conditioning circuit 12 may provide a regulated voltage signal for charging battery 17 as a backup power source for industrial/commercial device(s) 22a while external power supply 32 provides a regulated voltage signal for powering industrial/commercial device(s) 22a. Additionally, Ethernet power supply/industrial/commercial device 4H may provide a regulated voltage signal for powering an additional external industrial/commercial device(s) 22b. Alternatively, system 21 of FIG. 9 may comprise battery 17 internal to Ethernet power supply/industrial/commercial device 4H (i.e., part of and within Ethernet power supply/industrial/commercial device 4H).

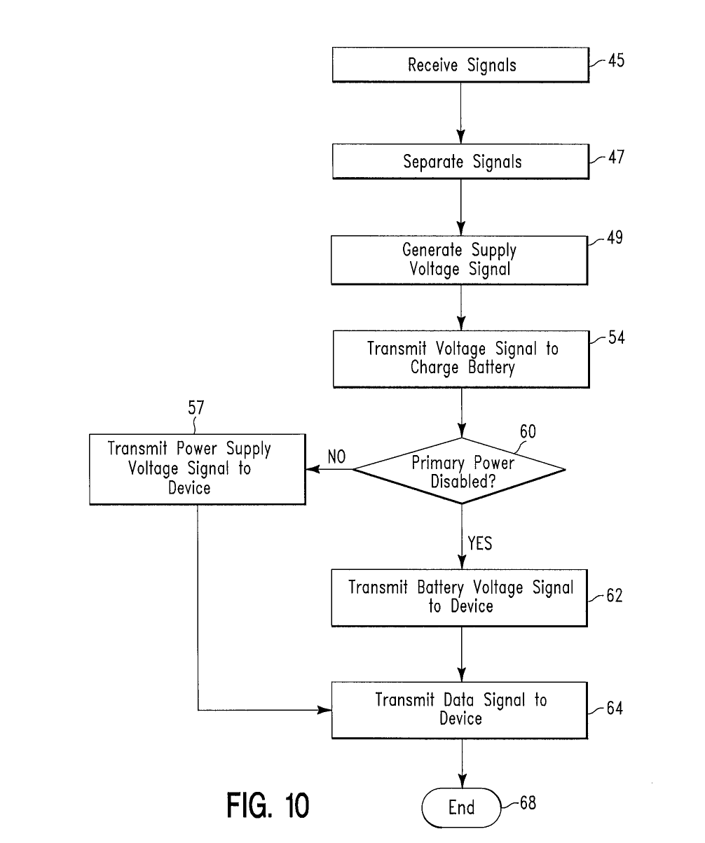

FIG. 10 illustrates a flowchart describing an algorithm used by systems 2A-2G of FIGS. 1-9 for retrieving a power signal from an Ethernet cable and generating a regulated voltage output signal for powering an industrial/commercial device, in accordance with embodiments of the present invention. In step 45, an Ethernet power supply (e.g., any of Ethernet power supplies 4A-4F of FIGS. 1-7) retrieves a data signal (e.g., I/O signals) and a power signal (e.g., power over Ethernet (POE)) from an Ethernet cable (e.g., Ethernet cable 7 of FIGS. 1-7). In step 47, the Ethernet power supply separates the data signal from the power signal. In step 49, the Ethernet power supply generates a regulated voltage output signal from the power signal retrieved in step 45. The regulated voltage output signal is suitable for powering or supplying power for an industrial/commercial device (e.g., industrial/commercial device(s) 22, 22a, 22b, etc) and/or charging an electrical energy voltage storage device (e.g., battery 17, capacitor 21, etc). In step 54, the regulated voltage output signal is optionally transmitted to charge an electrical energy storage device (e.g., battery 17, capacitor 21, etc). In step 60, it is determined if the primary power supply (e.g., power supply 32 of FIG. 7) has been disabled.

If in step 60, it is determined that the primary power supply (e.g., power supply 32 of FIG. 7) has not been disabled then in step 57, the regulated voltage output signal from the primary power supply (e.g., power supply 32 of FIG. 7) is transmitted to an industrial/commercial device(s) requiring power. In step 64, the data signal is transmitted to the industrial/commercial device(s) (e.g., industrial/commercial device 22, 22a, 22b, etc) and the process terminates in step 68.

If in step 60, it is determined that the primary power supply (e.g., power supply 32 of FIG. 7) has been disabled then in step 62, the regulated voltage output signal is transmitted from the electrical energy storage device (e.g., battery 17, capacitor 21, etc) to the industrial/commercial device(s) (e.g., industrial/commercial device(s) 22, 22a, 22b, etc) and step 64 is executed as described, supra. The process terminates in step 68.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A power supply comprising:
an Ethernet cable connector configured to interface said power supply to an Ethernet cable, wherein said Ethernet cable connector is further configured to receive a first voltage signal and an Ethernet data signal from said Ethernet cable;
a receiving circuit electrically connected to said Ethernet cable connector, wherein said receiving circuit is configured to separate said first voltage signal from said Ethernet data signal;
a voltage regulator/power conditioning circuit electrically connected to said receiving circuit, wherein said voltage regulator/power conditioning circuit is configured to generate a second voltage signal from said first voltage signal, wherein said second voltage signal comprises a different voltage from said first voltage signal, and wherein said second voltage signal is configured as a first power source for a first industrial/commercial device;
a first interface output connector electrically connected to said voltage regulator/power conditioning circuit, wherein said first interface output connector is configured to electrically connect said second voltage signal to said first industrial/commercial device; and
a second industrial/commercial device internal to said power supply, wherein said voltage regulator/power conditioning circuit is electrically connected to said internal industrial/commercial device, and wherein said second voltage signal is configured as a power source for said second internal industrial/commercial device.

2. The power supply of claim 1, wherein said voltage regulator/power conditioning circuit comprises an adjustment circuit configured to vary a voltage value of said second voltage signal.

3. The power supply of claim 1, wherein said second voltage signal comprises a common industrial voltage signal selected from the group consisting of 12 volts direct current (VDC) and 24 VDC.

4. The power supply of claim 1, further comprising:
a voltage directing circuit, wherein said industrial/commercial device is configured to receive a third voltage signal from a primary power apparatus, wherein said third voltage signal is configured as a primary power source for said first industrial/commercial device, and wherein said voltage directing circuit is configured to direct said second voltage signal from said voltage regulator/power conditioning circuit to said first interface output connector if said third voltage signal is disabled.

5. The power supply of claim 4, wherein said third voltage signal from said primary power apparatus is directed through said power supply, wherein said third voltage signal comprises a higher voltage than said second voltage signal, and wherein said voltage directing circuit is further configured to direct said third voltage signal through said first interface output connector to said first industrial/commercial device.

6. The power supply of claim 5, wherein said external primary power apparatus and said power supply in combination form an uninterruptible power source (UPS).

7. The power supply of claim 4, wherein said second voltage signal is further configured to charge an electrical energy storage device, and wherein said electrical energy storage device is configured as a second power source for supplying a fourth voltage signal to said first industrial/commercial device if said second voltage signal and said third voltage signal is disabled.

8. The power supply of claim 7, wherein said electrical energy storage device is selected from the group consisting of a battery and a capacitor.

9. The power supply of claim 1, wherein said second voltage signal further is configured to charge an electrical energy storage device, and wherein said electrical energy storage device is configured as a second power source for supplying a third voltage signal to said first industrial/commercial device if said second voltage signal is disabled.

10. The power supply of claim 9, wherein said power supply comprises said electrical energy storage device.

11. The power supply of claim 9, wherein said electrical energy storage device is selected from the group consisting of a battery and a capacitor.

12. An electrical system comprising the power supply and the electrical energy storage device of claim 9, wherein the electrical energy storage device is external to the power supply, and wherein the electrical energy storage device is electrically connected to an output of the power supply.

13. The power supply of claim 9, further comprising:
a voltage directing circuit, wherein said voltage directing circuit is configured to direct said third voltage signal to said first industrial/commercial device if said second voltage signal is disabled.

14. The power supply of claim 9, further comprising:
a switching circuit, wherein said switching circuit is configured to connect said third voltage signal or said second voltage signal to said first industrial/commercial device.

15. The power supply of claim 9, further comprising:
a voltage directing circuit, wherein said first industrial/commercial device is integral to said power supply, and wherein said voltage directing circuit is configured to direct said third voltage signal to said first industrial/commercial device if said second voltage signal is disabled.

16. A method for forming the power supply of claim 1, said method comprising electrically connecting said Ethernet connector to said receiving circuit, said voltage regulator/power conditioning circuit to said receiving circuit, and said first interface output connector to said voltage regulator/power conditioning circuit such that said receiving circuit is electrically connected to said Ethernet connector, said voltage regulator/power conditioning circuit is electrically connected to said receiving circuit, and said first interface output connector electrically is connected to said voltage regulator/power conditioning circuit.

17. The power supply of claim 1, further comprising:
a second interface output connector electrically connected to said receiving circuit, wherein said second interface output connector is configured to electrically connect said Ethernet data signal to said first industrial/commercial device.

18. The power supply of claim 17, wherein said voltage regulator/power conditioning circuit comprises an adjustment circuit configured to vary a voltage value of said second voltage signal.

19. The power supply of claim 17, wherein said second voltage signal comprises a common industrial voltage signal selected from the group consisting of 12 volts direct current (VDC) and 24 VDC.

20. The power supply of claim 17, further comprising:
a voltage directing circuit, wherein said first industrial/commercial device is configured to receive a third voltage signal from an external primary power apparatus, wherein said third voltage signal is configured as a primary power source for said first industrial/commercial device, and wherein said voltage directing circuit is configured to direct said second voltage signal from said voltage regulator/power conditioning circuit to said first interface output connector if said third voltage signal is disabled.

21. The power supply of claim 20, wherein said third voltage signal from said external primary power apparatus is directed through said power supply, wherein said third voltage signal comprises a higher voltage than said second voltage signal, and wherein said voltage directing circuit is further configured to direct said third voltage signal through said first interface output connector to said first industrial/commercial device.

22. The power supply of claim 21, wherein said external primary power apparatus and said power supply in combination form an uninterruptible power source (UPS).

23. The power supply of claim 20, wherein said second voltage signal is further configured to charge an electrical energy storage device, and wherein said storage device is configured as a second power source for supplying a fourth voltage signal to said first industrial/commercial device if said second voltage signal and said third voltage signal is disabled.

24. The power supply of claim 23, wherein said electrical energy storage device is selected from the group consisting of a battery and a capacitor.

25. The power supply of claim 17, wherein said second voltage signal further is configured to charge an electrical energy storage device, and wherein said electrical energy storage device is configured as a second power source for supplying a third voltage signal to said first industrial/commercial device if said second voltage signal is disabled.

26. The power supply of claim 25, wherein said power supply comprises said electrical energy storage device.

27. The power supply of claim 25, wherein said electrical energy storage device is selected from the group consisting of a battery and a capacitor.

28. An electrical system comprising the power supply and the electrical energy storage device of claim 25, wherein the electrical energy storage device is external to the power supply, and wherein the electrical energy storage device is electrically connected to an output of the power supply.

29. The power supply of claim 25, further comprising:
a voltage directing circuit, wherein said voltage directing circuit is configured to direct said third voltage signal to said first industrial/commercial device if said second voltage signal is disabled.

30. The power supply of claim 25, further comprising:
a switching circuit, wherein said switching circuit is configured to connect said third voltage signal or said second voltage signal to said first industrial/commercial device.

31. The power supply of claim 25, further comprising:
a voltage directing circuit, wherein said first industrial/commercial device is integral to said power supply, and wherein said voltage directing circuit is configured to direct said third voltage signal to said first industrial/commercial device if said second voltage signal is disabled.

32. A power supply comprising:
an Ethernet cable connector configured to interface said power supply to an Ethernet cable, wherein said Ethernet cable connector is further configured to receive a first voltage signal and an Ethernet data signal from said Ethernet cable;
a receiving circuit electrically connected to said Ethernet cable connector, wherein said receiving circuit is configured to separate said first voltage signal from said Ethernet data signal;
a voltage regulator/power conditioning circuit electrically connected to said receiving circuit, wherein said voltage regulator/power conditioning circuit is configured to generate a second voltage signal from said first voltage signal, wherein said second voltage signal comprises a different voltage from said first voltage signal, wherein said second voltage signal is configured to charge an electrical energy storage device, wherein said electrical energy storage device is configured as a second power source for supplying a third voltage signal to a first industrial/commercial device if a fourth voltage signal from an external primary power source for said first industrial/commercial device is disabled;
a first interface output connector electrically connecting said voltage regulator/power conditioning circuit to said electrical energy storage device, wherein said first interface output connector is configured to electrically connect said second voltage signal to said electrical energy storage device; and
a second industrial/commercial device internal to said power supply, wherein said electrical energy storage device is electrically connected to said second industrial/commercial device, and wherein said wherein said third voltage signal is configured as a power source for said second industrial/commercial device.

33. The power supply of claim 32, wherein said external primary power source and said electrical energy storage device in combination form an uninterruptible power source (UPS).

34. The power supply of claim 32, wherein said electrical energy storage device is selected from the group consisting of a battery and a capacitor.

35. The power supply of claim 32, wherein said power supply comprises said electrical energy storage device.

36. An electrical system comprising the power supply and the electrical energy storage device of claim 32, wherein the electrical energy storage device is external to the power supply, and wherein the electrical energy storage device is electrically connected to an output of the power supply.

37. A method comprising:
receiving, by a power supply, a first voltage signal and an Ethernet data signal from an Ethernet cable, said power supply comprising an Ethernet connector, a receiving circuit electrically connected to said Ethernet connector, a voltage regulator/power conditioning circuit electrically connected to said receiving circuit, a first interface output connector electrically connected to said voltage regulator/power conditioning circuit, and a second industrial/commercial device internal to said power supply, wherein said voltage regulator/power conditioning circuit is electrically connected to said second industrial/commercial device, and wherein said power supply interfaced to said to an Ethernet cable by said Ethernet connector;
separating, by said receiving circuit, said first voltage signal from said Ethernet data signal; and
generating, by said voltage regulator/power conditioning circuit, a second voltage signal from said first voltage signal, wherein said second voltage signal comprises a different voltage value from said first voltage signal, wherein said second voltage signal is configured as a first power source for a first industrial/commercial device, wherein said wherein said second voltage signal is configured as a power source for said second industrial/commercial device, and wherein said interface output connector is configured to electrically connect said second voltage signal to said industrial/commercial device.

38. The method of claim 37, wherein said voltage regulator/power conditioning circuit comprises an adjustment circuit, and wherein said method further comprises:
varying, by said adjustment circuit, a value of said second voltage signal.

39. The method of claim 37, wherein said second voltage signal comprises a common industrial voltage signal selected from the group consisting of 12 volts direct current (VDC) and 24 VDC.

40. The method of claim 37, wherein said power supply further comprises a voltage directing circuit, wherein said first industrial/commercial device is configured to receive a third voltage signal from an external primary power apparatus, wherein said third voltage signal is configured as a primary power source for said first industrial/commercial device, wherein said third voltage signal is disabled, and wherein said method further comprises:
directing, by said voltage directing circuit, said second voltage signal from said voltage regulator/power conditioning circuit to said first interface output connector.

41. The method of claim 37, wherein said power supply further comprises a voltage directing circuit, wherein said first industrial/commercial device is configured to receive a third voltage signal from an external primary power apparatus, wherein said third voltage signal is configured as a primary power source for said first industrial/commercial device, wherein said third voltage signal from said external primary power apparatus is directed through said power supply, wherein said third voltage signal comprises a higher voltage than said second voltage signal, and wherein said method further comprises:
directing, by said voltage directing circuit, said third voltage signal through said first interface output connector to said first industrial/commercial device.

42. The method of claim 41, wherein said external primary power apparatus and said power supply in combination form an uninterruptible power source (UPS).

43. The method of claim 37, wherein said power supply further comprises a voltage directing circuit, wherein said first industrial/commercial device is configured to receive a third voltage signal from an external primary power apparatus, wherein said third voltage signal is configured as a primary power source for said first industrial/commercial device, and wherein said method further comprises:
charging, by said second voltage signal, a voltage storage device, wherein said voltage storage device is configured as a second power source for supplying a fourth voltage signal to said first industrial/commercial device.

44. The method of claim 43, wherein said second voltage signal and said third voltage signal is disabled, and wherein said method further comprises:
supplying, by said voltage storage device, said fourth voltage signal to said first industrial/commercial device.

45. The method of claim 43, wherein said voltage storage device is selected from the group consisting of a battery and a capacitor.

46. The method of claim 37, further comprising:
charging, by said second voltage signal, an electrical energy storage device, wherein said voltage storage device is configured as a second power source for supplying a third voltage signal to said first industrial/commercial device if said second voltage signal is disabled.

47. The method of claim 46, wherein said power supply further comprises a voltage directing circuit, and wherein said method further comprises:
directing, by said voltage directing circuit, said third voltage signal to said first industrial/commercial device if said second voltage signal is disabled.

48. The method of claim 37, wherein said power supply further comprises a second interface output connector electrically connected to said receiving circuit, and wherein said method further comprises:
electrically connecting, by said second interface output connector, said Ethernet data signal to said first industrial/commercial device.

49. The method of claim 48, wherein said voltage regulator/power conditioning circuit comprises an adjustment circuit, and wherein said method further comprises:
varying, by said adjustment circuit, a value of said second voltage signal.

50. The method of claim 48, wherein said second voltage signal comprises a common industrial voltage signal selected from the group consisting of 12 volts direct current (VDC) and 24 VDC.

51. The method of claim 48, wherein said power supply further comprises a voltage directing circuit, wherein said first industrial/commercial device is configured to receive a third voltage signal from an external primary power apparatus, wherein said third voltage signal is configured as a primary power source for said first industrial/commercial device, wherein said third voltage signal is disabled, and wherein said method further comprises:
directing, by said voltage directing circuit, said second voltage signal from said voltage regulator/power conditioning circuit to said first interface output connector.

52. The method of claim 48, wherein said power supply further comprises a voltage directing circuit, wherein said first industrial/commercial device is configured to receive a third voltage signal from an external primary power apparatus, wherein said third voltage signal is configured as a primary power source for said first industrial/commercial device, wherein said third voltage signal from said external primary power apparatus is directed through said power supply, wherein said third voltage signal comprises a higher voltage than said second voltage signal, and wherein said method further comprises:
directing, by said voltage directing circuit, said third voltage signal through said first interface output connector to said first industrial/commercial device.

53. The method of claim 52, wherein said external primary power apparatus and said power supply in combination form an uninterruptible power source (UPS).

54. The method of claim 48, wherein said power supply further comprises a voltage directing circuit, wherein said first industrial/commercial device is configured to receive a third voltage signal from an external primary power apparatus, wherein said third voltage signal is configured as a primary power source for said first industrial/commercial device, and wherein said method further comprises:
charging, by said second voltage signal, a voltage storage device, wherein said voltage storage device is configured as a second power source for supplying a fourth voltage signal to said first industrial/commercial device.

55. The method of claim 54, wherein said second voltage signal and said third voltage signal is disabled, and wherein said method further comprises:
supplying, by said voltage storage device, said fourth voltage signal to said first industrial/commercial device.

56. The method of claim 54, wherein said voltage storage device is selected from the group consisting of a battery and a capacitor.

57. The method of claim 48, further comprising:
charging, by said second voltage signal, an electrical energy storage device, wherein said voltage storage device is configured as a second power source for supplying a third voltage signal to said first industrial/commercial device if said second voltage signal is disabled.

58. The method of claim 57, wherein said power supply further comprises a voltage directing circuit, and wherein said method further comprises:
directing, by said voltage directing circuit, said third voltage signal to said first industrial/commercial device if said second voltage signal is disabled.

59. The power supply of claim 1, wherein said voltage regulator/power conditioning circuit comprises a current limiting circuit configured to provide over voltage protection and short circuit protection for said first industrial/commercial device and said second industrial/commercial device.

60. The power supply of claim 1, wherein said power supply is located in an enclosure configured to protect said Ethernet connector, said receiving circuit, said voltage regulator/power conditioning circuit, said first interface output connector electrically, and said second industrial/commercial device from weather related elements and industrial elements.

61. The power supply of claim 1, wherein said first commercial/Industrial device comprises a first I/O device used in a controls/data acquisition environment, and wherein said second commercial/Industrial device comprises a second I/O device used in said controls/data acquisition environment.

62. The power supply of claim 61, wherein said first I/O device differs from said second I/O device.

63. The power supply of claim 61, wherein said second commercial/Industrial device is selected from the group consisting of an industrial instrumentation device, a monitoring device, and a control device.
